(19) United States
(12) Patent Application Publication
(10) Pub. No.: US 2019/0039352 A1
(43) Pub. Date: Feb. 7, 2019

(54) COVER ASSEMBLY FOR AN ELECTRONIC DEVICE, METHOD OF MANUFACTURE, AND DEVICE COMPRISING THE COVER ASSEMBLY

(71) Applicant: SABIC Global Technologies B.V., Bergen op Zoom (NL)

(72) Inventors: Wei Zhao, Mt. Vernon, IN (US); Michael M. Laurin, San Pedro, CA (US); Xiaoyu Sun, Downingtown, PA (US); Jong-Min Choi, Gyeonggi-do (KR); Timothy Michael Allessio, Mt. Vernon, IN (US)

(21) Appl. No.: 16/073,554

(22) PCT Filed: Jan. 27, 2017
(86) PCT No.: PCT/US2017/015271

§ 371 Date: Jul. 27, 2018

Related U.S. Application Data
(60) Provisional application No. 62/411,133, filed on Oct. 21, 2016.
(60) Provisional application No. 62/375,997, filed on Aug. 17, 2016.
(60) Provisional application No. 62/288,596, filed on Jan. 29, 2016.
(60) Provisional application No. 62/355,393, filed on Jun. 28, 2016.

(51) Int. Cl. B32B 17/06; B32B 7/12

(52) U.S. Cl. CPC B32B 17/064; B32B 7/12; F21V 3/06; B32B 2307/558; B32B 2457/20; B32B 2307/412

(57) ABSTRACT

A cover assembly for an electronic device includes a glass layer having a first surface and a second surface opposite the first surface, a first having a first surface and a second surface opposite the first surface, and an optically clear polymer film disposed on the optically clear adhesive on a side opposite the glass layer, the polymer film comprising a thermoplastic polymer. The cover assembly transmits greater than 85% of visible light as determined according to ASTM D1003-00. A method of manufacturing the cover assembly is also described. The cover assembly can be useful for use with an electronic device.

### BACKGROUND

Electronic devices, including mobile electronic devices, personal electronic devices, handheld electronic devices, and electronic devices incorporated as components in a household appliance or in the transportation industry, typically include a display (e.g., a liquid crystal display). Covers for such displays are of interest for protecting the display of various electronic devices, for example, from scratches, moisture, impact, and the like. Covers including glass and polymeric materials have been explored. Polymer-containing or “plastic” covers can suffer from poor scratch resistance. Glass covers have also been explored, as glass can be transparent and can be resilient to abrasion and thus can be suitable as a cover. However, while glass typically provides enhanced scratch resistance compared to plastic covers, glass can be brittle and susceptible to cracking and failure (e.g., when impacted along an edge). Glass covers also suffer from limitations relating to materials cost and ease of manufacture. Thicker glasses have been explored for improved resistance to impact, however this approach is often undesirable, resulting in thicker, heavier devices. Significant research has also been done to improve the impact properties of glass through altering the glass composition, chemically treating the glass, tempering the glass, and the like. However, these altered glasses tend to be brittle, particularly when a thin layer is used.

Accordingly, there remains a continuing need in the art for an improved cover for an electronic device, for example where the cover is transparent such that it can be applied to a display of an electronic device or as a cover for a lighting device without substantially affecting the transmission of visible light.

### BRIEF DESCRIPTION

A cover assembly for an electronic device comprises a glass layer having a first surface and a second surface opposite the first surface; a first optically clear adhesive layer disposed on at least a portion of the first surface of the glass layer; and an optically clear polymer film disposed on the optically clear adhesive on a side opposite the glass layer, the polymer film comprising a thermoplastic polymer; wherein the cover assembly transmits greater than 85% of visible light as determined according to ASTM D1003-00.

A method of manufacturing the cover assembly comprises applying the optically clear adhesive to at least a portion of the first surface of the glass layer; and applying the polymer film to the optically clear adhesive on a side opposite the first surface of the glass layer.

An electronic device comprising the cover assembly is also disclosed.

The above described and other features are exemplified by the following figures and detailed description.

### BRIEF DESCRIPTION OF THE DRAWINGS

The following figures are exemplary embodiments wherein the like elements are numbered alike.

FIG. 1 is a schematic illustration of a cross-sectional view of a cover assembly for an electronic device.

FIG. 2 is a schematic illustration of a cross-sectional view of a cover assembly for an electronic device having curvature in a direction perpendicular to the first and second surfaces of the glass layer.

FIG. 3 is a schematic illustration of a cross-sectional view of a cover assembly for an electronic device.

FIG. 4 is a schematic illustration of a cross-sectional view of a cover assembly for an electronic device including a conductive coating.

FIG. 5 shows the results of sharp impact testing for various samples.

FIG. 6 shows the results of sharp impact testing for various samples.

### DETAILED DESCRIPTION

The present inventors have discovered a cover assembly for an electronic device having a layered structure, in particular a glass/plastic laminated structure, where the cover assembly transmits greater than 85% of visible light, as determined according to ASTM D1003-00. Thus the cover assembly can be particularly useful as a front cover for an electronic device (e.g., in contact with a display of the electronic device), or as a cover for a lighting device. Furthermore, the cover assembly can advantageously exhibit low spall breakage properties.

Thus, one aspect of the present disclosure is a cover assembly for an electronic device. A cover assembly can be as shown in FIG. 1. As shown in FIG. 1, the cover assembly comprises a glass layer (1) having a first surface (3) and a second surface (2) opposite the first surface, a first optically clear adhesive layer (4) disposed on at least a portion of the first surface of the glass layer, and an optically clear polymer film (5) disposed on the optically clear adhesive on a side opposite the glass layer.

The glass layer can be, but is not limited to, chemically strengthened glass (e.g., CORNING™ GORILLA™ Glass commercially available from Corning Inc., XENSATION™ glass commercially available from Schott AG, DRAGONTRAIL™ glass commercially available from Asahi Glass Company, LTD, and CX-01 glass commercially available from Nippon Electric Glass Company, LTD, and the like), non-strengthened glass such as non-hardened glass including low sodium glass (e.g., CORNING™ WILLOW™ Glass commercially available from Corning Inc. and OA-10G Glass-on-Roll glass commercially available from Nippon Electric Glass Company, LTD, and the like), tempered glass, or optically transparent synthetic crystal (also referred to as sapphire glass, commercially available from GT Advanced Technologies Inc.).

In some embodiments, the glass layer can have a thickness of 50 micrometers to 25 millimeters, or 50 micrometers to 10 millimeters, or 50 micrometers to 1 millimeter, or 50 to 700 micrometers, or 100 to 550 micrometers. In some embodiments, the glass layer can have a thickness of greater than 450 micrometers, or 455 micrometers to 25 millimeters, or 475 micrometers to 2 millimeters, or 500 micrometers to 1 millimeter, or 550 micrometers to 1 millimeter.

In some embodiments, one or both surfaces of the glass layer can be a textured surface, which can provide, for example, anti-glare properties, anti-reflective properties, anti-microbial properties, and the like, or a combination comprising at least one of the foregoing.

In addition to the glass layer, the cover assembly comprises a first optically clear adhesive layer disposed on at least a portion of the first surface of the glass layer. In some embodiments, the optically clear adhesive layer is in adhesive contact with the entire first surface of the glass layer. As used herein, the term “optically clear adhesive” means that a 50 micrometer-thick sample of the optically clear adhesive transmits greater than 85% of visible light as determined according to ASTM D1003-00. The first optically clear adhesive layer can have a thickness of 1 to 2000 micrometers, or 1 to 1000 micrometers, or 1 to 500 micrometers, or 1 to 100 micrometers, or 10 to 100 micrometers, or 10 to 50 micrometers.

The adhesive can include epoxy, acrylate, amine, urethane, silicone, thermoplastic urethane, ethyl vinyl acetate, hindered amine light stabilizer free ethyl vinyl acetate (HALS free EVA), or a combination comprising at least one of the foregoing. In an embodiment, the adhesive is a hindered amine light stabilizer free ethyl vinyl acetate (HALS free EVA). In an embodiment the adhesive is a thermoplastic urethane, or an ultra violet light cured modified acrylate optical quality adhesive, or a silicone pressure sensitive adhesive, or an acrylate pressure sensitive adhesive. The adhesive can be applied using a process such as roll lamination, roller coating, screen printing, spreading, spray coating, spin coating, dip coating, and the like, or a combination comprising at least one of the foregoing techniques.

In addition to the glass layer and the first optically clear adhesive layer, the cover assembly further includes an optically clear polymer film. The optically clear polymer film is disposed on the optically clear adhesive on a side opposite the glass layer. Stated another way, the first optically clear adhesive is sandwiched between the optically clear polymer film and the first surface of the glass layer (as shown in FIG. 1). As used herein, the term “optically clear polymer film” means that a 100 micrometer-thick sample of the optically clear polymer film transmits greater than 85% of visible light as determined according to ASTM D1003-00. In some embodiments, the optically clear polymer film can have a thickness of 1 micrometer to 20 millimeters, or 5 micrometers to 20 millimeters, or 5 micrometers to 10 millimeters, or 5 micrometers to 1 millimeter, or 5 to 500 micrometers, or 25 to 125 micrometers. In some embodiments, the polymer film can have a thickness of less than 300 micrometers, or 1 to less than 300 micrometers, or 5 to 250 micrometers, or 25 to 125 micrometers. In a particularly advantageous embodiment, the cover assembly can preferably comprise a glass layer having a thickness of greater than 450 micrometers and a polymer film having a thickness of less than 300 micrometers. The cover assembly can advantageously provide enhanced impact performance, as further described in the working examples below.

The optically clear polymer film comprises a thermoplastic polymer. As used herein, the term “thermoplastic” refers to a material that is plastic or deformable, melts to a liquid when heated, and freezes to a brittle, glassy state when cooled sufficiently. Thermoplastics are typically high molecular weight polymers. Examples of thermoplastic polymers that can be used include polyacetals (e.g., polyoxyethylene and polyoxymethylene), poly(C₁₋₆ alkyl)acrylates, polyacrylamides, polyamides, (e.g., aliphatic polyamides, polyphthalamides, and polyaramides), polyamideimides, polyanhydrides, polyarylates, polyarylene ethers (e.g., polyphenylene ethers), polyarylene sulfides (e.g., polyphenylene sulfides), polyarylsulfones, polybenzothiazoles, polybenzoxazoles, polybenzimidazoles, polycarbonates (including polycarbonate copolymers such as polycarbonate-siloxanes, polycarbonate-esters, and polycarbonate-ester-siloxanes), polyesters (e.g., polyethylene terephthalates, polybutylene terephthalates, polyarylates, and polyester copolymers such as polyester-ethers), polyetheretherketones, polyetherimides (including copolymers such as polyetherimide-siloxane copolymers), polyetherketoneketones, polyetherketones, polyethersulfones, polyimides (including copolymers such as polyimide-siloxane copolymers), poly(C₁₋₆ alkyl)methacrylates, polymethacrylamides, polynorbornenes (including copolymers containing norbornenyl units) polyolefins (e.g., polyethylenes, polypropylenes, polytetrafluoroethylenes, and their copolymers, for example ethylene-alpha-olefin copolymers), polyoxadiazoles, polyoxymethylene, polyphthalides, polysilazanes, polysiloxanes, polystyrenes (including copolymers such as acrylonitrile-butadiene-styrene (ABS) and methyl methacrylate-butadiene-styrene (MBS)), polysulfides, polysulfonamides, polysulfonates, polysulfones, polythioesters, polytriazines, polyureas, polyurethanes, polyvinyl alcohols, polyvinyl esters, polyvinyl ethers, polyvinyl halides, polyvinyl nitriles, polyvinyl ketones, polyvinyl thioethers, polyvinylidene fluorides, or the like, or a combination comprising at least one of the foregoing thermoplastic polymers.

In some embodiments, the polymer film comprises a polyacetal, poly(C₁₋₆ alkyl)acrylate, polyarylate, polycarbonate, polyester, polyetherimide, polyimide, poly(C₁₋₆ alkyl)methacrylate, polyolefin, polystyrene, polyurethane, polyvinyl alcohol, polyvinyl ester, polyvinyl ether, polyvinyl halide, polyvinyl nitrile, polyvinyl ketone, polyvinylidene fluoride, or a combination comprising at least one of the foregoing thermoplastic polymers. In some embodiments, the polymer film comprises a polyimide, a polyetherimide, a polyester, a polyolefin, a polycarbonate, a (meth)acrylic polymer (e.g., poly(C₁₋₆ alkyl)acrylates, poly(C₁₋₆ alkyl)methacrylates, or a combination comprising at least one of the foregoing, preferably poly(methyl methacrylate)), a vinyl polymer, polyacetal (e.g., polyoxyethylene and polyoxymethylene), a styrenic polymer, or a combination comprising at least one of the foregoing. In some embodiments, the optically clear polymer film comprises a polyimide, a polyetherimide, a polyester, a polyolefin, a polycarbonate, or a combination comprising at least one of the foregoing.

In some embodiments, the optically clear polymer film comprises a polyimide. Polyimides comprise more than 1, for example 10 to 1000, or 10 to 500, or 10 to 100, structural units of formula (1)

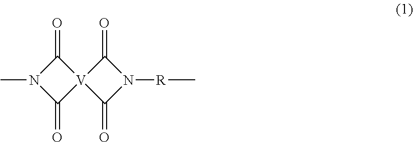

wherein each V is the same or different, and is a substituted or unsubstituted tetravalent C₄₋₄₀ hydrocarbon group, for example a substituted or unsubstituted C₆₋₂₀ aromatic hydrocarbon group, a substituted or unsubstituted, straight or branched chain, saturated or unsaturated C₂₋₂₀ aliphatic group, or a substituted or unsubstituted C₄₋₈ cycloalkylene group or a halogenated derivative thereof, in particular a substituted or unsubstituted C₆₋₂₀ aromatic hydrocarbon group. Exemplary aromatic hydrocarbon groups include any of those of the formulas

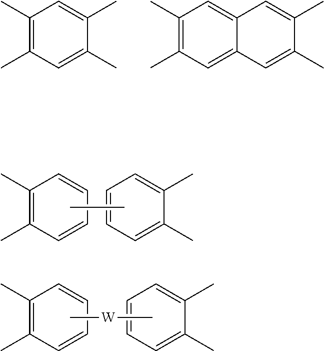

wherein W is —O—, —S—, —C(O)—, —SO₂—, —SO—, —C_{y}H_{2y}— wherein y is an integer from 1 to 5 or a halogenated derivative thereof (which includes perfluoroalkylene groups), or a group of the formula T as described in formula (3) below.

Each R in formula (1) is the same or different, and is a substituted or unsubstituted divalent organic group, such as a C₆₋₂₀ aromatic hydrocarbon group or a halogenated derivative thereof, a straight or branched chain C₂₋₂₀ alkylene group or a halogenated derivative thereof, a C₃₋₈ cycloalkylene group or halogenated derivative thereof, in particular a divalent group of formulas (2)

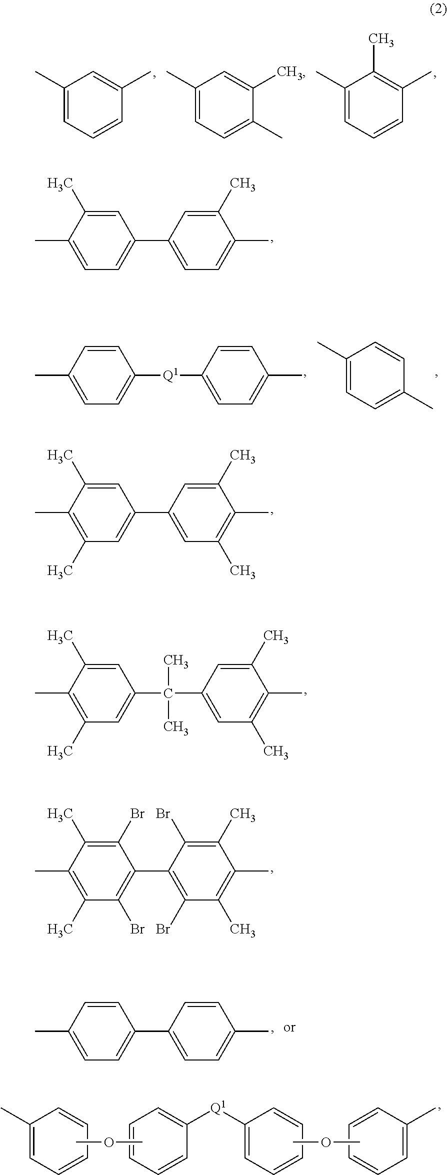

wherein Q¹ is —O—, —S—, —C(O)—, —SO₂—, —SO—, —C_{y}H_{2y}— wherein y is an integer from 1 to 5 or a halogenated derivative thereof (which includes perfluoroalkylene groups), or —(C₆H₁₀)_{z}— wherein z is an integer from 1 to 4. In an embodiment R is m-phenylene, p-phenylene, or a diaryl sulfone.

In some embodiments, the optically clear polymer film comprises a polyetherimide. Polyetherimides are a class of polyimides that comprise more than 1, for example 10 to 1000, or 10 to 500, structural units of formula (3)

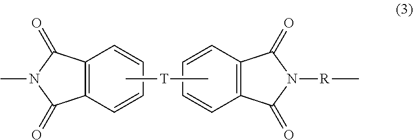

wherein each R is the same or different, and is as described in formula (1).

Further in formula (3), T is —O— or a group of the formula —O—Z—O— wherein the divalent bonds of the —O— or the —O—Z—O— group are in the 3,3′, 3,4′, 4,3′, or the 4,4′ positions. The group Z in —O—Z—O— is a substituted or unsubstituted divalent organic group, and can be an aromatic C₆₋₂₄ monocyclic or polycyclic moiety optionally substituted with 1 to 6 C₁₋₈ alkyl groups, 1 to 8 halogen atoms, or a combination comprising at least one of the foregoing, provided that the valence of Z is not exceeded. Exemplary groups Z include groups derived from a dihydroxy compound of formula (4)

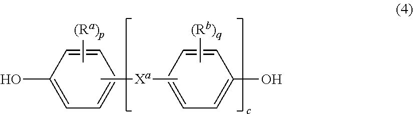

wherein R^{a} and R^{b} can be the same or different and are a halogen atom or a monovalent C₁₋₆ alkyl group, for example; p and q are each independently integers of 0 to 4; c is 0 to 4; and X^{a} is a bridging group connecting the hydroxy-substituted aromatic groups, where the bridging group and the hydroxy substituent of each C₆ arylene group are disposed ortho, meta, or para (specifically para) to each other on the C₆ arylene group. The bridging group X^{a} can be a single bond, —O—, —S—, —S(O)—, —S(O)₂—, —C(O)—, or a C₁₋₁₈ organic bridging group. The C₁₋₁₈ organic bridging group can be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. A specific example of a group Z is a divalent group of formula (4a)

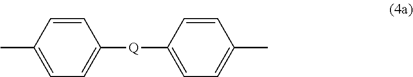

wherein Q is —O—, —S—, —C(O)—, —SO₂—, —SO—, or —C_{y}H_{2y}— wherein y is an integer from 1 to 5 or a halogenated derivative thereof (including a perfluoroalkylene group). In a specific embodiment Z is a derived from bisphenol A, such that Q in formula (4a) is 2,2-isopropylidene.

In an embodiment in formula (3), R is m-phenylene or p-phenylene and T is —O—Z—O— wherein Z is a divalent group of formula (4a). Alternatively, R is m-phenylene or p-phenylene and T is —O—Z—O— wherein Z is a divalent group of formula (4a) and Q is 2,2-isopropylidene.

In some embodiments, the polyetherimide can be a copolymer, for example, a polyetherimide sulfone copolymer comprising structural units of formula (3) wherein at least 50 mole percent of the R groups are of formula (2) wherein Q¹ is —SO₂— and the remaining R groups are independently p-phenylene or m-phenylene or a combination comprising at least one of the foregoing; and Z is 2,2′-(4-phenylene)isopropylidene. Alternatively, the polyetherimide copolymer optionally comprises additional structural imide units, for example imide units of formula (1) wherein R and V are as described in formula (1), for example V is

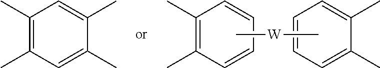

wherein W is a single bond, —S—, —C(O)—, —SO₂—, —SO—, or —C_{y}H_{2y}— wherein y is an integer from 1 to 5 or a halogenated derivative thereof (which includes perfluoroalkylene groups). These additional structural imide units preferably comprise less than 20 mol % of the total number of units, or can be present in amounts of 0 to 10 mol % of the total number of units, or 0 to 5 mol % of the total number of units, or 0 to 2 mole % of the total number of units. In some embodiments, no additional imide units are present in the polyetherimide.

The polyimide and polyetherimide can be prepared by any of the methods well known to those skilled in the art, including the reaction of an aromatic bis(ether anhydride) of formula (5a) or formula (5b)

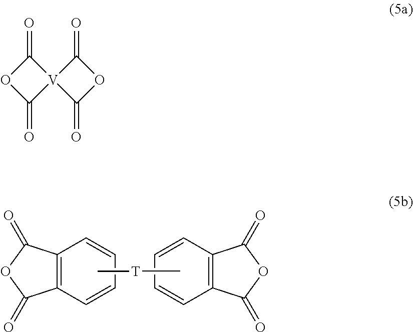

or a chemical equivalent thereof, with an organic diamine of formula (6)

H₂N—R—NH₂ (6)

wherein V, T, and R are defined as described above. Copolymers of the polyetherimides can be manufactured using a combination of an aromatic bis(ether anhydride) of formula (5) and a different bis(anhydride), for example a bis(anhydride) wherein T does not contain an ether functionality, for example T is a sulfone.

Illustrative examples of bis(anhydride)s include 3,3-bis[4-(3,4-dicarboxyphenoxy)phenyl]propane dianhydride; 4,4′-bis(3,4-dicarboxyphenoxy)diphenyl ether dianhydride; 4,4′-bis(3,4-dicarboxyphenoxy)diphenyl sulfide dianhydride; 4,4′-bis(3,4-dicarboxyphenoxy)benzophenone dianhydride; 4,4′-bis(3,4-dicarboxyphenoxy)diphenyl sulfone dianhydride; 2,2-bis[4-(2,3-dicarboxyphenoxy)phenyl]propane dianhydride; 4,4′-bis(2,3-dicarboxyphenoxy)diphenyl ether dianhydride; 4,4′-bis(2,3-dicarboxyphenoxy)diphenyl sulfide dianhydride; 4,4′-bis(2,3-dicarboxyphenoxy)benzophenone dianhydride; 4,4′-bis(2,3-dicarboxyphenoxy)diphenyl sulfone dianhydride; 4-(2,3-dicarboxyphenoxy)-4′-(3,4-dicarboxyphenoxy)diphenyl-2,2-propane dianhydride; 4-(2,3-dicarboxyphenoxy)-4′-(3,4-dicarboxyphenoxy)diphenyl ether dianhydride; 4-(2,3-dicarboxyphenoxy)-4′-(3,4-dicarboxyphenoxy)diphenyl sulfide dianhydride; 4-(2,3-dicarboxyphenoxy)-4′-(3,4-dicarboxyphenoxy)benzophenone dianhydride; and, 4-(2,3-dicarboxyphenoxy)-4′-(3,4-dicarboxyphenoxy)diphenyl sulfone dianhydride, as well as various combinations thereof.

Examples of organic diamines include hexamethylenediamine, polymethylated 1,6-n-hexanediamine, heptamethylenediamine, octamethylenediamine, nonamethylenediamine, decamethylenediamine, 1,12-dodecanediamine, 1,18-octadecanediamine, 3-methylheptamethylenediamine, 4,4-dimethylheptamethylenediamine, 4-methylnonamethylenediamine, 5-methylnonamethylenediamine, 2,5-dimethylhexamethylenediamine, 2,5-dimethylheptamethylenediamine, 2, 2-dimethylpropylenediamine, N-methyl-bis (3-aminopropyl) amine, 3-methoxyhexamethylenediamine, 1,2-bis(3-aminopropoxy) ethane, bis(3-aminopropyl) sulfide, 1,4-cyclohexanediamine, bis-(4-aminocyclohexyl) methane, m-phenylenediamine, p-phenylenediamine, 2,4-diaminotoluene, 2,6-diaminotoluene, m-xylylenediamine, p-xylylenediamine, 2-methyl-4,6-diethyl-1,3-phenylene-diamine, 5-methyl-4,6-diethyl-1,3-phenylene-diamine, benzidine, 3,3′-dimethylbenzidine, 3,3′-dimethoxybenzidine, 1,5-diaminonaphthalene, bis(4-aminophenyl) methane, bis(2-chloro-4-amino-3,5-diethylphenyl) methane, bis(4-aminophenyl) propane, 2,4-bis(p-amino-t-butyl) toluene, bis(p-amino-t-butylphenyl) ether, bis(p-methyl-o-aminophenyl) benzene, bis(p-methyl-o-aminopentyl) benzene, 1, 3-diamino-4-isopropylbenzene, bis(4-aminophenyl) sulfide, bis-(4-aminophenyl) sulfone (also known as 4,4′-diaminodiphenyl sulfone (DDS)), and bis(4-aminophenyl) ether. Any regioisomer of the foregoing compounds can be used. Combinations of these compounds can also be used. In some embodiments the organic diamine is m-phenylenediamine, p-phenylenediamine, 4,4′-diaminodiphenyl sulfone, or a combination comprising at least one of the foregoing.

The polyimides and polyetherimides can have a melt index of 0.1 to 10 grams per minute (g/min), as measured by American Society for Testing Materials (ASTM) D1238 at 340 to 370° C., using a 6.7 kilogram (kg) weight. In some embodiments, the polyetherimide polymer has a weight average molecular weight (Mw) of 1,000 to 150,000 grams/mole (Dalton), as measured by gel permeation chromatography, using polystyrene standards. In some embodiments the polyetherimide has an Mw of 10,000 to 80,000 Daltons. Such polyetherimide polymers typically have an intrinsic viscosity greater than 0.2 deciliters per gram (dl/g), or, more specifically, 0.35 to 0.7 dl/g as measured in m-cresol at 25° C.

Suitable polyimides can include KAPTON™, commercially available from DuPont. Suitable polyetherimides can include ULTEM™ and EXTEM™, commercially available from SABIC.

In some embodiments, the optically clear polymer film can include a polycarbonate. “Polycarbonate” as used herein means a polymer or copolymer having repeating structural carbonate units of formula (7)

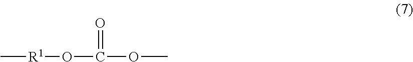

wherein at least 60 percent of the total number of R¹ groups are aromatic, or each R¹ contains at least one C₆₋₃₀ aromatic group. Specifically, each R¹ can be derived from a dihydroxy compound such as an aromatic dihydroxy compound of formula (8) or a bisphenol of formula (9).

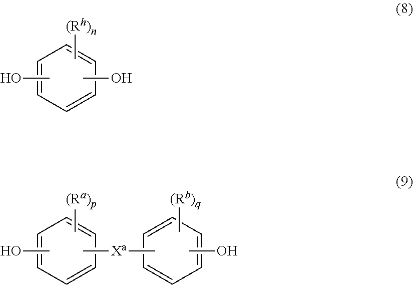

In formula (8), each R^{h} is independently a halogen atom, for example bromine, a C₁₋₁₀ hydrocarbyl group such as a C₁₋₁₀ alkyl, a halogen-substituted C₁₋₁₀ alkyl, a C₆₋₁₀ aryl, or a halogen-substituted C₆₋₁₀ aryl, and n is 0 to 4.

In formula (9), R^{a} and R^{h} are each independently a halogen, C₁₋₁₂ alkoxy, or C₁₋₁₂ alkyl, and p and q are each independently integers of 0 to 4, such that when p or q is less than 4, the valence of each carbon of the ring is filled by hydrogen. In an embodiment, p and q is each 0, or p and q is each 1, and R^{a} and R^{h} are each a C₁₋₃ alkyl group, specifically methyl, disposed meta to the hydroxy group on each arylene group. X^{a} is a bridging group connecting the two hydroxy-substituted aromatic groups, where the bridging group and the hydroxy substituent of each C₆ arylene group are disposed ortho, meta, or para (specifically para) to each other on the C₆ arylene group, for example, a single bond, —O—, —S—, —S(O)—, —S(O)₂—, —C(O)—, or a C₁₋₁₈ organic group, which can be cyclic or acyclic, aromatic or non-aromatic, and can further comprise heteroatoms such as halogens, oxygen, nitrogen, sulfur, silicon, or phosphorous. For example, X^{a} can be a substituted or unsubstituted C₃₋₁₈ cycloalkylidene; a C₁₋₂₅ alkylidene of the formula —C(R^{c})(R^{d})— wherein R^{c} and R^{d} are each independently hydrogen, C₁₋₁₂ alkyl, C₁₋₁₂ cycloalkyl, C₇₋₁₂ arylalkyl, C₁₋₁₂ heteroalkyl, or cyclic C₇₋₁₂ heteroarylalkyl; or a group of the formula —C(═R^{e})— wherein R^{c} is a divalent C₁₋₁₂ hydrocarbon group.

Examples of bisphenol compounds include 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis (hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantane, alpha,alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorene, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalimide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole; resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, or the like.

Specific dihydroxy compounds include resorcinol, 2,2-bis(4-hydroxyphenyl) propane (“bisphenol A” or “BPA”), 3,3-bis(4-hydroxyphenyl) phthalimidine, 2-phenyl-3,3′-bis(4-hydroxyphenyl) phthalimidine (also known as N-phenyl phenolphthalein bisphenol, “PPPBP”, or 3,3-bis(4-hydroxyphenyl)-2-phenylisoindolin-1-one), 1,1-bis(4-hydroxy-3-methylphenyl)cyclohexane, and 1,1-bis(4-hydroxyphenyl)-3,3,5-trimethylcyclohexane (isophorone bisphenol).

“Polycarbonate” as used herein also includes copolymers comprising carbonate units and ester units (“poly(ester-carbonate)s”, also known as polyester-polycarbonates). Poly(ester-carbonate)s further contain, in addition to recurring carbonate chain units of formula (7), repeating ester units of formula (10)

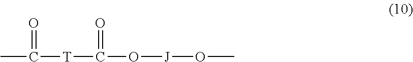

wherein J is a divalent group derived from a dihydroxy compound (which includes a reactive derivative thereof), and can be, for example, a C₂₋₁₀ alkylene, a C₆₋₂₀ cycloalkylene a C₆₋₂₀ arylene, or a polyoxyalkylene group in which the alkylene groups contain 2 to 6 carbon atoms, specifically, 2, 3, or 4 carbon atoms; and T is a divalent group derived from a dicarboxylic acid (which includes a reactive derivative thereof), and can be, for example, a C₂₋₂₀ alkylene, a C₆₋₂₀ cycloalkylene, or a C₆₋₂₀ arylene. Copolyesters containing a combination of different T or J groups can be used. The polyester units can be branched or linear.

Specific dihydroxy compounds include aromatic dihydroxy compounds of formula (8) (e.g., resorcinol), bisphenols of formula (9) (e.g., bisphenol A), a C₁₋₈ aliphatic diol such as ethane diol, n-propane diol, i-propane diol, 1,4-butane diol, 1,6-cyclohexane diol, 1,6-hydroxymethylcyclohexane, or a combination comprising at least one of the foregoing dihydroxy compounds. Aliphatic dicarboxylic acids that can be used include C₆₋₂₀ aliphatic dicarboxylic acids (which includes the terminal carboxyl groups), specifically linear C₈₋₁₂ aliphatic dicarboxylic acid such as decanedioic acid (sebacic acid); and alpha, omega-C₁₂ dicarboxylic acids such as dodecanedioic acid (DDDA). Aromatic dicarboxylic acids that can be used include terephthalic acid, isophthalic acid, naphthalene dicarboxylic acid, 1,6-cyclohexane dicarboxylic acid, or a combination comprising at least one of the foregoing acids. A combination of isophthalic acid and terephthalic acid wherein the weight ratio of isophthalic acid to terephthalic acid is 91:9 to 2:98 can be used.

Specific ester units include ethylene terephthalate units, n-proplyene terephthalate units, n-butylene terephthalate units, ester units derived from isophthalic acid, terephthalic acid, and resorcinol (ITR ester units), and ester units derived from sebacic acid and bisphenol A. The molar ratio of ester units to carbonate units in the poly(ester-carbonate)s can vary broadly, for example 1:99 to 99:1, specifically, 10:90 to 90:10, more specifically, 25:75 to 75:25, or from 2:98 to 15:85. In some embodiments the molar ratio of ester units to carbonate units in the poly(ester-carbonate)s can vary from 1:99 to 30:70, specifically 2:98 to 25:75, more specifically 3:97 to 20:80, or from 5:95 to 15:85.

In a specific embodiment, the polycarbonate is a linear homopolymer containing bisphenol A carbonate units (BPA-PC), commercially available under the trade name LEXAN from SABIC; or a branched, cyanophenol end-capped bisphenol A homopolycarbonate produced via interfacial polymerization, containing 3 mol % 1,1,1-tris(4-hydroxyphenyl)ethane (THPE) branching agent, commercially available under the trade name LEXAN CFR from SABIC. A combination of a linear polycarbonate and a branched polycarbonate can be used. It is also possible to use a polycarbonate copolymer or interpolymer rather than a homopolymer. Polycarbonate copolymers can include copolycarbonates comprising two or more different types of carbonate units, for example units derived from BPA and PPPBP (commercially available under the trade name XHT from SABIC); BPA and DMBPC (commercially available under the trade name DMX from SABIC); or BPA and isophorone bisphenol (commercially available under the trade name APEC from Bayer). The polycarbonate copolymers can further comprise non-carbonate repeating units, for example repeating ester units (polyester-carbonates), such as those comprising resorcinol isophthalate and terephthalate units and bisphenol A carbonate units, such as those commercially available under the trade name LEXAN SLX from SABIC; bisphenol A carbonate units and isophthalate-terephthalate-bisphenol A ester units, also commonly referred to as poly(carbonate-ester)s (PCE) or poly(phthalate-carbonate)s (PPC), depending on the relative ratio of carbonate units and ester units; or bisphenol A carbonate units and C₆₋₁₂ dicarboxy ester units such as sebacic ester units (commercially available under the trade name HFD from SABIC) Other polycarbonate copolymers can comprise repeating siloxane units (polycarbonate-siloxanes), for example those comprising bisphenol A carbonate units and siloxane units (e.g., blocks containing 5 to 200 dimethylsiloxane units), such as those commercially available under the trade name EXL from SABIC; or both ester units and siloxane units (polycarbonate-ester-siloxanes), for example those comprising bisphenol A carbonate units, isophthalate-terephthalate-bisphenol A ester units, and siloxane units (e.g., blocks containing 5 to 200 dimethylsiloxane units), such as those commercially available under the trade name FST from SABIC. Combinations of any of the above materials can be used.

Combinations of polycarbonates with other polymers can be used, for example an alloy of bisphenol A polycarbonate with an ester such as poly(butylene terephthalate) or poly(ethylene terephthalate), each of which can be semicrystalline or amorphous. Such combinations are commercially available under the trade name XENOY and XYLEX from SABIC.

A specific copolycarbonate includes bisphenol A and bulky bisphenol carbonate units, i.e., derived from bisphenols containing at least 12 carbon atoms, for example 12 to 60 carbon atoms or 20 to 40 carbon atoms. Examples of such copolycarbonates include copolycarbonates comprising bisphenol A carbonate units and 2-phenyl-3,3′-bis(4-hydroxyphenyl) phthalimidine carbonate units (a BPA-PPPBP copolymer, commercially available under the trade designation LEXAN XHT from SABIC), a copolymer comprising bisphenol A carbonate units and 1,1-bis(4-hydroxy-3-methylphenyl)cyclohexane carbonate units (a BPA-DMBPC copolymer commercially available under the trade designation LEXAN DMC from SABIC, or a copolymer comprising bisphenol A carbonate units and isophorone bisphenol carbonate units (commercially available under the trade name APEC from Bayer). A combination of linear polycarbonate and a branched polycarbonate can be used. Moreover, combinations of any of the above materials may be used.

The polycarbonates can have an intrinsic viscosity, as determined in chloroform at 25° C., of 0.3 to 1.5 deciliters per gram (dl/gm), specifically 0.45 to 1.0 dl/gm. The polycarbonates can have a weight average molecular weight of 10,000 to 200,000 Daltons, specifically 20,000 to 100,000 Daltons, as measured by gel permeation chromatography (GPC), using a crosslinked styrene-divinylbenzene column and calibrated to polycarbonate references. GPC samples are prepared at a concentration of 1 mg per ml, and are eluted at a flow rate of 1.5 ml per minute.

In some embodiments, the optically clear polymer film can include a polyester (e.g., polyethylene terephthalates, polybutylene terephthalates, polyarylates, and polyester copolymers such as polyester-ethers). In some embodiments, the polyester can include a poly(ethylene terephthalate), a glycol-modified poly(ethylene terephthalate), a poly(ethylene naphthalate), poly(1,4-cyclohexane-dimethanol-1,4-cyclohexane dicarboxylate), poly(cyclohexanedimethylene terephthalate)-co-poly(ethylene terephthalate), or a combination comprising at least one of the foregoing polyesters.

In some embodiments, the optically clear polymer film can include a polyolefin. Representative examples of polyolefins as thermoplastic polymers are polyethylene, polypropylene, polybutylene, polymethylpentene (and co-polymers thereof), polynorbornene (and co-polymers thereof), poly(l-butene), poly(3-methylbutene), poly(4-methylpentene) and copolymers of ethylene with propylene, 1-butene, 1-hexene, 1-octene, 1-decene, 4-methyl-1-pentene and 1-octadecene. Representative combinations of polyolefins are combinations containing polyethylene and polypropylene, low-density polyethylene and high-density polyethylene, and polyethylene and olefin copolymers containing copolymerizable monomers, some of which are described above, e.g., ethylene and acrylic acid copolymers; ethyl and methyl acrylate copolymers; ethylene and ethyl acrylate copolymers; ethylene and vinyl acetate copolymers-, ethylene, acrylic acid, and ethyl acrylate copolymers, and ethylene, acrylic acid, and vinyl acetate copolymers. In some embodiments, the thermoplastic polymer can include a polyolefin elastomer.

In some embodiments, the optically clear polymer film can include a vinyl polymer, for example, polyvinyl alcohols, polyvinyl esters, polyvinyl ethers, polyvinyl halides (e.g., polyvinyl fluoride), polyvinyl nitriles, polyvinyl ketones, polyvinyl thioethers, or a combination comprising at least one of the foregoing. In some embodiments, the optically clear polymer film can include a styrenic polymer, for example polystyrene and copolymers thereof including acrylonitrile-butadiene-styrene (ABS) and methyl methacrylate-butadiene-styrene (MBS).

In some embodiments, the polymer film comprises a polyetherimide according to formula (3) wherein R is m-phenylene or p-phenylene and T is —O—Z—O— wherein Z is a divalent group of formula (4a) and Q is 2,2-isopropylidene, poly(ethylene terephthalate); a polyetherimide sulfone copolymer comprising structural units of formula (3) wherein at least 50 mole % of the R groups are of formula (2) wherein Q¹ is —SO₂— and the remaining R groups are independently p-phenylene or m-phenylene or a combination comprising at least one of the foregoing and Z is 2,2′-(4-phenylene)isopropylidene; poly(ethylene naphthalate); poly(1,4-cyclohexane-dimethanol-1,4-cyclohexane dicarboxylate); poly(cyclohexanedimethylene terephthalate)-co-poly(ethylene terephthalate); polyethylene; polypropylene; a bisphenol A polycarbonate homopolymer; a bisphenol A polycarbonate copolymer; poly(4,4′-oxydiphenylene-pyromellitimide); polyvinylidene fluoride; polyvinyl fluoride; poly(methyl methacrylate); polystyrene; polyoxymethylene; ethyl vinyl acetate; polymethylpentane; or a combination comprising at least one of the foregoing. In some embodiments, the polymer film consists of a polycarbonate (i.e., no polymer other than the polycarbonate is present in the polymer film).

In some embodiments, one or both surfaces of the polymer film can be a textured surface, which can provide, for example, anti-glare properties, anti-reflective properties, anti-microbial properties, and the like, or a combination comprising at least one of the foregoing.

The cover assembly comprising the glass layer, the first optically clear adhesive layer, and the optically clear polymer film is preferably a transparent cover assembly, for example, the cover assembly transmits greater than 85% of visible light as determined according to ASTM D1003-00. A cover assembly that transmits greater than 85% of visible light can be particularly useful for front covers of electronic devices (i.e., wherein the cover assembly is applied to a display of the electronic device) or as covers for lighting devices.

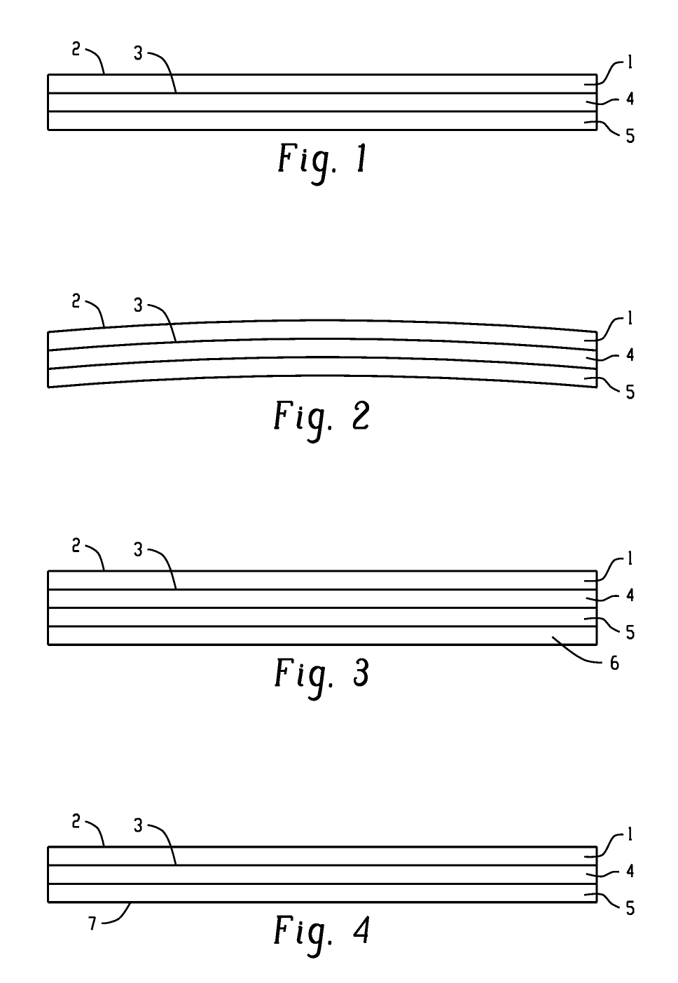

In some embodiments, the cover assembly can exhibit curvature in one or more directions, preferably in one direction. Preferably, the cover assembly can exhibit curvature in a direction that is perpendicular to the first and second surface of the glass layer, for example as shown in FIG. 2. In some embodiments, the cover assembly can have a pre-determined three dimensional shape. In some embodiments, the cover assembly can be at least partially curvilinear (i.e., have a curvilinear configuration). In some embodiments, the radius of curvature of a curvilinear cover assembly can be fixed or can vary over the length of the cover assembly.

In addition to the glass layer, the first optically clear adhesive layer, and the optically clear polymer film, the cover assembly can optionally further include one or more additional layers. For example, in some embodiments, the cover assembly can optionally further include a second optically clear adhesive layer. Preferably, the second optically clear adhesive layer is disposed on at least a portion of the polymer film, on a side opposite the first optically clear adhesive. An example of a cover assembly including a second optically clear adhesive layer is depicted in FIG. 3. Specifically, FIG. 3 shows the cover assembly comprising a glass layer (1) having a first surface (3) and a second surface (2) opposite the first surface, a first optically clear adhesive layer (4) disposed on at least a portion of the first surface of the glass layer, and an optically clear polymer film (5) disposed on the first optically clear adhesive on a side opposite the glass layer. The second optically clear adhesive (6) is disposed on the polymer film (5) opposite the first optically clear adhesive layer. The second optically clear adhesive layer can be the same or different from the first optically clear adhesive layer. In some embodiments, the second optically clear adhesive layer functions to adhere the cover assembly to an electronic device (e.g., a display of the electronic device).

In some embodiments, the cover assembly can further include one or more functional layers. A functional layer can be disposed on at least a portion of the glass layer, the polymer film, or both. In some embodiments, a functional layer is preferably disposed on both sides of the glass layer, both sides of the polymer layer, or both. The optional functional layer can include an ultraviolet light protection layer, a touch sensing layer, abrasion resistant layer, infrared absorbing layer, infrared reflecting layer, hydrophobic layer, hydrophilic layer, anti-fingerprint layer, anti-smudge layer, anti-glare layer, anti-reflection layer, antimicrobial layer, conductive layer, electromagnetic radiation shielding layer (e.g., an electromagnetic interference shielding layer), anti-frost layer, anti-fog layer, image forming layer (e.g., an ink layer), or a combination including at least one of the foregoing. In some embodiments, the functional layer can preferably include an anti-reflection layer, an anti-glare layer, an antimicrobial layer, a conductive layer, an anti-fingerprint layer, an anti-smudge layer, an anti-fog layer, or a combination comprising at least one of the foregoing. In some embodiments, the functional layer can further be textured. The functional layer can be disposed in any form, e.g., a film, coating, coextruded layer, deposited layer, molded layer, or the like.

In an embodiment, the cover assembly further comprises a functional layer comprising conductive layer. The conductive layer can be disposed on at least a portion of the polymer film, on a side opposite the first optically clear adhesive. A cover assembly according to this embodiment is depicted in FIG. 4, where a conductive layer (7) is disposed on the polymer film, on a side opposite the first optically clear adhesive. In some embodiments, the cover assembly can include a first conductive layer disposed on at least a portion of the polymer film between the first optically clear adhesive and the polymer film, and a second conductive layer disposed on at least a portion of the polymer film, on a side opposite the first conductive layer. In other words, in some embodiments, the polymer film can be sandwiched between a first and a second conductive layer. When present, the conductive layer is optically transparent, such that a 5 micrometer thick sample of the conductive layer transmits greater than 80% of visible light as determined according to ASTM D1003-00.

The transparent conductive layer can include indium tin oxide, carbon nanotubes, graphene, conductive metal nanowires, conductive metal nanoparticles (e.g., silver nanoparticles), a conductive nanomesh (including a self-assembling conductive nanomesh, for example formed from conductive metal nanoparticles), or a combination comprising at least one of the foregoing.

In some embodiments, the cover assembly can further include a decorative pattern disposed on at least a portion of the glass layer, the polymer film, or both. The decorative pattern can be applied to the glass layer or the polymer film by screen printing, laser marking, digital inkjet printing, digital conductive inkjet printing, sublimation, offset printing, digital offset printing, roto gravure printing, pad printing, transfer printing, metallization, vacuum metallization, powder coating, spray painting, painting by hand, or a combination of at least one of the foregoing application techniques. In some embodiments, the pattern can be applied so as to provide a dead front graphic or display, where the display appears tinted or mirrored when not lit, and shows the graphics when backlit or a display when the display is turned on. In some embodiments, the decorative pattern is provided at an edge of the cover assembly (e.g., as a border).

The cover assembly can be manufactured by applying the first optically clear adhesive to at least a portion of the first surface of the glass layer, and applying the polymer film to the optically clear adhesive on a side opposite the first surface of the glass layer. The adhesive can be applied using any suitable process including, but not limited to, roll lamination, roller coating, screen printing, spreading, spray coating, spin coating, dip coating, and the like, or a combination comprising at least one of the foregoing techniques. The polymer film can be prepared using any method for preparing a polymer film that is generally known. For example, the polymer film can be prepared by extrusion, solution casting, melt blowing, and the like. When present, the one or more additional layers can be applied in the desired position in the cover assembly. For example, when the cover assembly include a second optically clear adhesive layer, the second optically clear adhesive layer can be application to the polymer film on a side opposite the first optically clear adhesive. The layers can generally be assembled in any order to provide the desired cover assembly. In some embodiments, when the cover assembly includes a first and a second conductive layer coating each side of the polymer film, the first and the second conductive layers can be applied to the polymer film (simultaneously or consecutively) prior to applying the polymer film (including the conductive layers) to the first optically clear adhesive on a side opposite the first surface of the glass layer. In some embodiments, particularly where the cover assembly exhibits curvature, has a pre-determined three dimensional shape, or is at least partially curvilinear, the individual layers of the cover assembly can be molded into the desired shape, and subsequently laminated together to form the cover assembly. In particular, the glass layer can be molded into the desired shape and the adhesive can then be applied to the glass layer. The polymer film can be applied to the optically clear adhesive on a side opposite the first surface of the glass layer to provide the cover assembly having the desired shape or curvature.

The cover assemblies of the present disclosure can be useful for a wide variety of applications, including consumer electronics and electronics used in the transportation industry. Accordingly, an electronic device comprising the cover assembly represents another aspect of the present disclosure. In some embodiments, the cover assembly can be disposed on a display of an electronic device. The displays can be flat displays, curved displays, curvilinear displays, or irregularly shaped displays. Examples of electronic devices that can be utilized with the cover assembly include, but are not limited to, a cellular telephone, a smart telephone, a laptop computer, a notebook computer, a tablet computer, a television, a console (e.g., an appliance console or an automotive console, particularly an automotive interior center console), a medical device, a monitor, a smart window, public information displays, or a wearable electronic device (e.g., smart watch, activity tracker, health tracker, health monitoring devices, and the like). In some embodiments, the display on which the cover assembly is disposed can be a heads-up display, a display console, or a touch screen display. Alternatively, an electronic device for use with the cover assembly can be a lighting device. In some embodiments where the cover assembly is used as a cover for a lighting device, the cover assembly can further serve as a barrier layer for oxygen and moisture, such that no additional barrier layer is required.

In some embodiments, the cover assembly is laminated onto the electronic or lighting device, molded onto the electronic or lighting device, or welded onto the device, preferably by laser welding, vibration welding, or ultrasonic welding, or the like, or adhered onto the electronic or lighting device via an adhesive layer, or joined with the device by any other industrially applicable joining techniques. When an adhesive layer is used, a 50 micrometer thick sample of the adhesive layer transmits greater than 85% of visible light as determined according to ASTM D1003-00. In some embodiments, the adhesive layer used to adhere the cover assembly onto the electronic or lighting device is the second optically clear adhesive layer described above.

In some embodiments, the cover assembly can exhibit curvature in one or more directions, preferably in a direction perpendicular to the first and second surfaces of the glass layer, and the display of the electronic device exhibits a curvature that is complementary to the curvature of the cover assembly. In some embodiments, the cover assembly can exhibit a curvilinear configuration, and the display of the electronic device exhibits a curvilinear configuration that is complementary to that of the cover assembly.

The cover assembly described herein provides a light weight cover for an electronic or lighting device. The cover assembly exhibits transmission of greater than 85% of visible light, as determined according to ASTM D1003-00, and can advantageously exhibit low spall breakage properties. Thus a significant improvement in cover assemblies for electronic and lighting devices is provided by the present disclosure.

The cover assemblies described herein are further illustrated by the following examples, which are non-limiting.

### EXAMPLES

Sharp tip impact testing was conducted using a stainless steel impactor. The impactor was dropped with the sharp tip impacting the sample laid on a steel plate at increasing heights ranging from 0.1 meters to 3.25 meters, until failure was achieved. The energy of the impactor was calculated according to the formula

E=mgh

where E is the energy of the impactor, m is the mass of the impactor in kilograms, g is gravitational acceleration (9.8145 m/s²), and h is the height at which failure is achieved (i.e., the height at which the impactor breaks the sample).

The materials used for the following examples are described in Table 1.

TABLE 1

| Material | Description |
|---|---|
| Glass-1 | Chemically-strengthened glass obtained as XENSATION from |
| | Abrisa Technologies |
| Glass-2 | Chemically-strengthened GORILLA glass, commercially |
| | available from Corning, Inc. |
| Glass-3 | Non-strengthened soda lime glass |
| OCA | Optically clear adhesive available as Optically Clear Adhesive |
| | 8146 from 3M. |
| Si-PSA | Silicone pressure sensitive adhesive available as SR-29 from |
| | Adhesives Research |
| PC | Polycarbonate, available under the tradename LEXAN ™ |
| | 8010MC from SABIC |
| PET | Polyester film available as Lumirror ™ T60 film, available |
| | from Toray |

Laminates prepared from the materials described in Table 1 for Examples 1 and 2 and Comparative Examples 1 and 2 are provided in Table 2 below.

TABLE 2

| | | | | | | Polymer |
|---|---|---|---|---|---|---|
| | | Glass | | Adhesive | | film |
| | | Thickness | | thickness | Polymer | thickness |
| Example | Glass | (mm) | Adhesive | (mm) | film | (mm) |
| E1 | Glass-2 | 0.55 | Si-PSA | 0.05 | PC | 0.127 |
| CE1 | Glass-2 | 0.55 | — | — | — | — |
| E2 | Glass-3 | 1 | Si-PSA | 0.05 | PC | 0.127 |
| CE2 | Glass-3 | 1 | — | — | — | — |

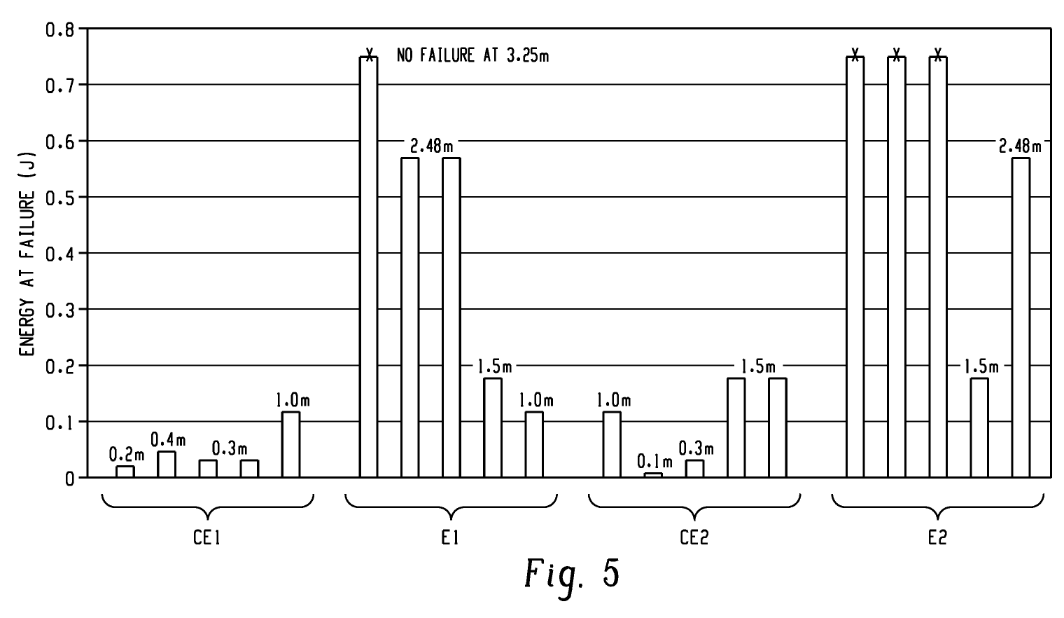

Each of the samples listed in Table 2 were tested as described above, and the results are shown in Table 3. For each example, 5 samples were tested at varying drop heights. As shown in Table 3, no failure was observed for either E1 or E2, with the laminated samples exhibiting no breakage when tested with a 23.5 gram impactor at a height of 3.25 meters (the energy of the impactor was 0.7496 Joules). In contrast, the samples of CE1 and CE2 exhibited breakage at significantly lower impactor energies. From the data shown in Table 3, it can be seen that the laminated samples E1 and E2 exhibit improved sharp tip impact resistance relative to the corresponding bare glass samples (CE1 and CE2, respectively), as evidence by the larger energies of impactor at failure for E1 and E2. The results of the impact testing are also shown in FIG. 5.

TABLE 3

| Drop | | | | |
|---|---|---|---|---|
| Height | Energy of impactor at failure (J) | | | |
| (m) | E1 | CE1 | E2 | CE2 |
| 0.1 | | | | 0.012 |
| 0.2 | | 0.02394 | | |
| 0.3 | | 0.0359; | | 0.0359 |
| | | 0.0359 | | |
| 0.4 | | 0.0479 | | |
| 1.0 | 0.1197 | 0.1197 | | 0.1197 |
| 1.5 | 0.1796 | | 0.1796 | 0.1796; |
| | | | | 0.1796 |
| 2.48 | 0.572; 0.572 | | 0.572 | |
| 3.25 | DNF¹ | | DNF; DNF; DNF¹ | |

¹DNF indicates sample did not fail

Laminates prepared from the materials described in Table 1 for Examples 3-10 and Comparative Example 3 are provided in Table 4 below. The laminates of E3-10 and CE3 were tested using a 20 gram sharp tip impactor. The experimental set up for the impact testing of E3-10 and CE3 used a minimal testing height of 100 millimeters, and a maximum testing height of 1000 millimeters. The impact testing results from E3-10 and CE3 are shown in Table 5.

TABLE 4

| | | | | | | Polymer |
|---|---|---|---|---|---|---|
| | | Glass | | Adhesive | | film |
| | | Thickness | | thickness | Polymer | thickness |
| Example | Glass | (mm) | Adhesive | (mm) | film | (mm) |
| E3 | Glass-1 | 0.55 | OCA | 0.05 | PC | 0.127 |
| E4 | Glass-1 | 0.55 | OCA | 0.1 | PC | 0.127 |
| E5 | Glass-1 | 0.55 | Si-PSA | 0.05 | PC | 0.127 |
| E6 | Glass-1 | 0.55 | Si-PSA | 0.1 | PC | 0.127 |
| E7 | Glass-1 | 0.55 | OCA | 0.05 | PC | 0.05 |
| E8 | Glass-1 | 0.55 | OCA | 0.1 | PC | 0.05 |
| E9 | Glass-1 | 0.55 | Si-PSA | 0.05 | PC | 0.05 |
| E10 | Glass-1 | 0.55 | Si-PSA | 0.1 | PC | 0.05 |
| CE3 | Glass-1 | 0.55 | — | — | — | — |

TABLE 5

| | |
|---|---|
| Height¹ (mm) | Energy of impactor (J) |

| | | Standard | | Standard |
|---|---|---|---|---|
| Example | Average | deviation | Average | deviation |
| E3 | 187.50 | 57.28 | 0.0368 | 0.0112 |
| E4 | 159.38 | 24.80 | 0.0313 | 0.0049 |
| E5 | 275.00 | 57.28 | 0.0540 | 0.0112 |
| E6 | 203.13 | 47.50 | 0.0399 | 0.0093 |
| E7 | 325.00 | 132.29 | 0.0638 | 0.0260 |
| E8 | 212.50 | 72.89 | 0.0417 | 0.0143 |
| E9 | 240.63 | 55.81 | 0.0472 | 0.0110 |
| E10 | 153.13 | 61.79 | 0.0300 | 0.0121 |
| CE3 | <100 | | <0.02 | |

¹Highest height at which the glass did not break

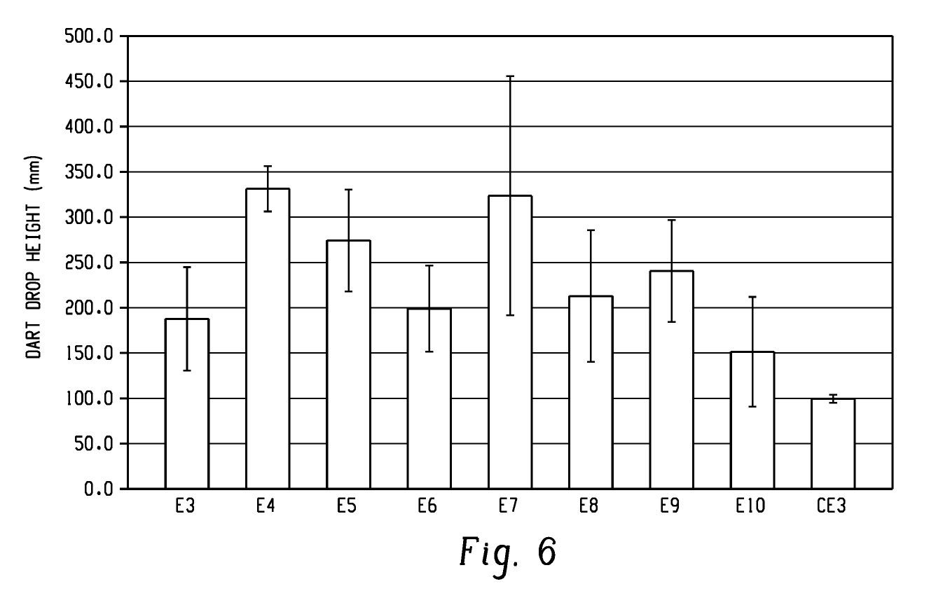

The results of the impact testing for Examples 3-10 and Comparative Example 3 are also shown in FIG. 6. In FIG. 6, it can be seen that laminate samples E3-E10 exhibited a greater tolerance towards the sharp tip impact testing, indicated by the higher height at which the laminate was able to withstand impact. Comparative Example 3, which is bare, chemically strengthened i glass (“Glass-1”), broke at the minimal testing height of 100 millimeters. Thus, as shown in Table 5 and FIG. 6, the laminates according to the present disclosure have enhanced impact performance compared to the bare glass sample. Furthermore, comparing the results of Examples 3, 5, 7, and 9 with the results for Examples 4, 6, 8, and 10, respectively, it can be seen that the thinner adhesive layers lead to improved sharp tip impact performance of the resulting laminates.

Examples 11-13 and Comparative Example 4, shown in Table 6, are exemplary laminates prepared from Glass-2. The laminates of E11-13 and CE4 were tested using a 20 gram sharp tip impactor. The impact testing results from E11-13 and CE4 are shown in Table 7. Due to limits of the testing height, there were several samples that showed no failure (marked as “DNF”, indicating that the sample did not fail.

TABLE 6

| | | | | | | Polymer |
|---|---|---|---|---|---|---|
| | | Glass | | Adhesive | | film |
| | | Thickness | | thickness | Polymer | thickness |
| Example | Glass | (mm) | Adhesive | (mm) | film | (mm) |
| E11 | Glass-2 | 0.55 | Si-PSA | 0.05 | PC | 0.127 |
| E12 | Glass-2 | 0.55 | Si-PSA | 0.025 | PC | 0.05 |
| E13 | Glass-2 | 0.55 | Si-PSA | 0.025 | PC | 0.05 |
| CE4 | Glass-2 | 0.55 | — | — | — | — |

TABLE 7

| Example | Impactor height (mm) | | | | | | | |
|---|---|---|---|---|---|---|---|---|
| E11 | 725 | 400 | 275 | 875 | 475 | DNF¹ | 450 | 750 |
| E12 | 525 | 450 | 525 | DNF1 | 450 | 600 | DNF¹ | 225 |
| E13 | DNF¹ | DNF¹ | DNF¹ | 725 | DNF¹ | DNF¹ | 425 | DNF¹ |
| CE4 | 75 | 125 | 125 | 125 | — | — | — | — |

¹DNF indicates sample did not fail

As shown in Table 7, the laminate samples according to the present disclosure (Example 11-13) each exhibited enhanced impact performance the Comparative Example 4 (bare Glass-2).

Examples 14-15 and Comparative Example 5, shown in Table 8, illustrate the use of two different polymer films (PC and PET) for the preparation of laminates from Glass-2. The laminates of Examples 14-15 and Comparative Example 5 were tested using a ball drop test conducted with a stainless steel ball weighing 44.6 grams and having a diameter of 22.18 mm. The samples to be tested were placed on a granite top measuring 25 mm thick. The steel ball was dropped from a specified height on to the glass surface of the laminate or glass. The height was increased by 25 mm increments from 100 mm to 1000 mm, until the glass was broken. The last height before glass breakage was observed was recorded and the energy of the ball was calculated with the previously provided formula. The results of the ball drop test are shown in Table 9.

TABLE 8

| | | | | | | Polymer |
|---|---|---|---|---|---|---|
| | | Glass | | Adhesive | | film |
| | | Thickness | | thickness | Polymer | thickness |
| Example | Glass | (mm) | Adhesive | (mm) | film | (mm) |
| E14 | Glass-2 | 0.55 | Si-PSA | 0.05 | PC | 0.127 |
| E15 | Glass-2 | 0.55 | Si-PSA | 0.05 | PET | 0.127 |
| CE5 | Glass-2 | 0.7 | | | | |

TABLE 9

| Example | Ball drop height (mm) | | | | | | | |
|---|---|---|---|---|---|---|---|---|
| E14 | 300 | 750 | 750 | 700 | 650 | DNF¹ | 850 | DNF¹ |
| E15 | 300 | 750 | 750 | 700 | 750 | DNF¹ | 700 | DNF¹ |
| CE5 | 125 | 100 | 150 | 150 | 100 | 100 | 100 | 175 |

¹DNF indicates sample did not fail

As shown in Table 9, the laminate samples according to the present disclosure (Example 14-15) each exhibited enhanced impact performance the Comparative Example 5 (bare Glass-2), and can thus withstand a higher impact energy compared to the bare Glass-2 sample of CE5.

This disclosure further encompasses the following non-limiting embodiments.

### Embodiment 1

A cover assembly for an electronic device, comprising a glass layer having a first surface and a second surface opposite the first surface; a first optically clear adhesive layer disposed on at least a portion of the first surface of the glass layer, wherein a 50 micrometer-thick sample of the optically clear adhesive transmits greater than 85% of visible light as determined according to ASTM D1003-00; and an optically clear polymer film disposed on the optically clear adhesive on a side opposite the glass layer, the polymer film comprising a thermoplastic polymer, wherein a 100 micrometer-thick sample of the optically clear polymer film transmits greater than 85% of visible light as determined according to ASTM D1003-00; wherein the cover assembly transmits greater than 85% of visible light as determined according to ASTM D1003-00.

### Embodiment 2

The cover assembly of embodiment 1, wherein the glass layer has a thickness of 50 micrometers to 25 millimeters, or 50 micrometers to 1 millimeter, or 50 micrometers to 0.7 millimeter, or 100 to 550 micrometers; or greater than 450 micrometers, or 455 micrometers to 25 millimeters, or 475 micrometers to 2 millimeters, or 500 micrometers to 1 millimeter, or 550 micrometers to 1 millimeter.

### Embodiment 3

The cover assembly of embodiment 1 or 2, wherein the glass layer comprises chemically strengthened glass, non-strengthened glass, tempered glass, or optically transparent synthetic crystal.

### Embodiment 4

The cover assembly of any one or more of embodiments 1 to 3, wherein the optically clear adhesive layer comprises epoxy, acrylate, amine, urethane, silicone, thermoplastic urethane, ethyl vinyl acetate, hindered amine light stabilizer free ethyl vinyl acetate, or a combination comprising at least one of the foregoing.

### Embodiment 5

The cover assembly of any one or more of embodiments 1 to 4, wherein the optically clear adhesive has a thickness of 1 to 2000 micrometers, preferably 10 to 100 micrometers, more preferably 10 to 50 micrometers.

### Embodiment 6

The cover assembly of any one or more of embodiments 1 to 5, wherein the polymer film comprises a polyacetal, poly(C₁₋₆ alkyl)acrylate, polyarylate, polycarbonate, polyester, polyetherimide, polyimide, poly(C₁₋₆ alkyl)methacrylate, polyolefin, polystyrene, polyurethane, polyvinyl alcohol, polyvinyl ester, polyvinyl ether, polyvinyl halide, polyvinyl nitrile, polyvinyl ketone, polyvinylidene fluoride, or a combination comprising at least one of the foregoing thermoplastic polymers, preferably wherein the polymer film comprises poly(ethylene terephthalate), poly(ethylene naphthalate), poly(1,4-cyclohexane-dimethanol-1,4-cyclohexane dicarboxylate), poly(cyclohexanedimethylene terephthalate)-co-poly(ethylene terephthalate), polyethylene, polypropylene, a bisphenol A polycarbonate homopolymer, a bisphenol A polycarbonate copolymer, poly(4,4′-oxydiphenylene-pyromellitimide), polyvinylidene fluoride, polyvinyl fluoride, poly(methyl methacrylate), polystyrene, polyoxymethylene, ethyl vinyl acetate, polymethylpentane, or a combination comprising at least one of the foregoing.

### Embodiment 7

The cover assembly of any one or more of embodiments 1 to 6, wherein the polymer film has a thickness of 1 micrometer to 20 millimeters, preferably 5 micrometers to 20 millimeters, more preferably 5 micrometers to 10 millimeters, even more preferably 5 micrometers to 1 millimeter, even more preferably still 25 to 125 micrometers; or less than 300 micrometers, or 1 to less than 300 micrometers, or 5 to 250 micrometers, or 25 to 125 micrometers.

### Embodiment 8

The cover assembly of any one or more of embodiments 1 to 7, wherein the cover assembly further comprises a second optically clear adhesive layer, preferably wherein the second optically clear adhesive layer is disposed on at least a portion of the polymer film on a side opposite the first optically clear adhesive layer.

### Embodiment 9

The cover assembly of any one or more of embodiments 1 to 8, wherein the cover assembly further comprises a functional layer disposed on at least a portion of the glass layer, the polymer film, or both.

### Embodiment 10

The cover assembly of embodiment 9, wherein the functional layer is disposed on both sides of the glass layer, the polymer layer, or both.

### Embodiment 11

The cover assembly of embodiment 9 or 10, wherein the functional layer comprises an anti-reflection coating, an anti-glare coating, an antimicrobial coating, a conductive layer, an anti-fingerprint coating, an anti-smudge coating, an anti-fog coating, or a combination comprising at least one of the foregoing.

### Embodiment 12

The cover assembly of any one or more of embodiments 9 to 11, wherein the functional layer comprises a conductive layer disposed on at least a portion of the polymer film on a side opposite the first optically clear adhesive layer, wherein a 5 micrometer-thick sample of the conductive layer transmits greater than 80% of visible light as determined according to ASTM D1003-00.

### Embodiment 13

The cover assembly of any one or more of embodiments 9 to 12, wherein the transparent conductive layer comprises indium tin oxide, carbon nanotubes, graphene, conductive metal nanowires, conductive metal nanoparticles, a conductive nanomesh, or a combination comprising at least one of the foregoing.

### Embodiment 14

The cover assembly of any one or more of embodiments 1 to 13, further comprising a decorative pattern disposed on at least a portion of the glass layer, the polymer film, or both.

### Embodiment 15

The cover assembly of any one or more of embodiments 1 to 14, wherein the glass layer, the polymer film, or both is textured.

### Embodiment 16

The cover assembly of any one or more of embodiments 1 to 15, wherein the cover assembly exhibits curvature in a direction perpendicular to the first and second surfaces of the glass layer.

### Embodiment 17

The cover assembly of any one or more of embodiments 1 to 15, wherein the cover assembly is at least partially curvilinear.

### Embodiment 18

A method of manufacturing the cover assembly of any one or more of embodiments 1 to 17, the method comprising, applying the optically clear adhesive to at least a portion of the first surface of the glass layer; and applying the polymer film to the optically clear adhesive on a side opposite the first surface of the glass layer.

### Embodiment 19

An electronic device comprising the cover assembly of any one or more of embodiments 1 to 17.

### Embodiment 20

The electronic device of embodiment 19, comprising the cover assembly disposed on a display of the electronic device, preferably wherein the device is a cellular telephone, a smart telephone, a laptop computer, a notebook computer, a tablet computer, a television, a console (e.g., an appliance or automotive console), a medical device, a monitor, or a wearable electronic device.

### Embodiment 21

The electronic device of embodiment 20, wherein the display is heads-up display, a display console, or a touch screen display.

### Embodiment 22

The electronic device of embodiment 19, wherein the device is a lighting device.

### Embodiment 23

The electronic device of any one or more of embodiments 19 to 22, wherein the cover assembly is laminated onto the device, or molded onto the device, or welded onto the device, preferably by laser welding, vibration welding, or ultrasonic welding, or adhered onto the device via an adhesive layer, wherein a 50 micrometer-thick sample of the adhesive layer transmits greater than 85% of visible light as determined according to ASTM D1003-00.

### Embodiment 24

The electronic device of any one or more of embodiments 19 to 23, wherein the cover assembly exhibits curvature in a direction perpendicular to the first and second surfaces of the glass layer, and the display of the electronic device exhibits a curvature that is complementary to the curvature of the cover assembly.

### Embodiment 25

The electronic device of any one or more of embodiments 19 to 23, wherein the cover assembly exhibits a curvilinear configuration and the display of the electronic device exhibits a curvilinear configuration that is complementary to that of the cover assembly.

The compositions, methods, and articles can alternatively comprise, consist of, or consist essentially of, any appropriate components or steps herein disclosed. The compositions, methods, and articles can additionally, or alternatively, be formulated so as to be devoid, or substantially free, of any steps, components, materials, ingredients, adjuvants, or species that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “some embodiments”, “an embodiment”, and so forth, means that a particular element described in connection with the embodiment is included in at least one embodiment described herein, and may or may not be present in other embodiments. In addition, it is to be understood that the described elements may be combined in any suitable manner in the various embodiments.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

The term “alkyl” means a branched or straight chain, unsaturated aliphatic hydrocarbon group, e.g., methyl, ethyl, n-propyl, i-propyl, n-butyl, s-butyl, t-butyl, n-pentyl, s-pentyl, and n- and s-hexyl. “Alkenyl” means a straight or branched chain, monovalent hydrocarbon group having at least one carbon-carbon double bond (e.g., ethenyl (—HC═CH₂)). “Alkoxy” means an alkyl group that is linked via an oxygen (i.e., alkyl-O—), for example methoxy, ethoxy, and sec-butyloxy groups. “Alkylene” means a straight or branched chain, saturated, divalent aliphatic hydrocarbon group (e.g., methylene (—CH₂—) or, propylene (—(CH₂)₃—)). “Cycloalkylene” means a divalent cyclic alkylene group, —CₙH₂ₙ₋ₓ, wherein x is the number of hydrogens replaced by cyclization(s). “Cycloalkenyl” means a monovalent group having one or more rings and one or more carbon-carbon double bonds in the ring, wherein all ring members are carbon (e.g., cyclopentyl and cyclohexyl). “Aryl” means an aromatic hydrocarbon group containing the specified number of carbon atoms, such as phenyl, tropone, indanyl, or naphthyl. The prefix “halo” means a group or compound including one more of a fluoro, chloro, bromo, or iodo substituent. A combination of different halo groups (e.g., bromo and fluoro), or only chloro groups can be present. The prefix “hetero” means that the compound or group includes at least one ring member that is a heteroatom (e.g., 1, 2, or 3 heteroatom(s)), wherein the heteroatom(s) is each independently N, O, S, Si, or P. “Substituted” means that the compound or group is substituted with at least one (e.g., 1, 2, 3, or 4) substituents that can each independently be a C₁₋₉ alkoxy, a C₁₋₉ haloalkoxy, a nitro (—NO₂), a cyano (—CN), a C₁₋₆ alkyl sulfonyl (—S(═O)₂-alkyl), a C₆₋₁₂ aryl sulfonyl (—S(═O)₂-aryl) a thiol (—SH), a thiocyano (—SCN), a tosyl (CH₃C₆H₄SO₂—), a C₃₋₁₂ cycloalkyl, a C₂₋₁₂ alkenyl, a C₅₋₁₂ cycloalkenyl, a C₆₋₁₂ aryl, a C₇₋₁₃ arylalkylene, a C₄₋₁₂ heterocycloalkyl, and a C₃₋₁₂ heteroaryl instead of hydrogen, provided that the substituted atom's normal valence is not exceeded. The number of carbon atoms indicated in a group is exclusive of any substituents. For example —CH₂CH₂CN is a C₂ alkyl group substituted with a nitrile.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A cover assembly for an electronic device, comprising
a glass layer having a first surface and a second surface opposite the first surface;
a first optically clear adhesive layer disposed on at least a portion of the first surface of the glass layer; and
an optically clear polymer film disposed on the optically clear adhesive on a side opposite the glass layer, the polymer film comprising a thermoplastic polymer;
wherein the cover assembly transmits greater than 85% of visible light as determined according to ASTM D1003-00.

2. The cover assembly of claim 1, wherein the glass layer has a thickness of
50 micrometers to 25 millimeters; or
greater than 450 micrometers.

3. The cover assembly of claim 1, wherein the glass layer comprises chemically strengthened glass, non-strengthened glass, tempered glass, or optically transparent synthetic crystal.

4. The cover assembly of claim 1, wherein the optically clear adhesive layer comprises epoxy, acrylate, amine, urethane, silicone, thermoplastic urethane, ethyl vinyl acetate, hindered amine light stabilizer free ethyl vinyl acetate, or a combination comprising at least one of the foregoing.

5. The cover assembly of claim 1, wherein the optically clear adhesive has a thickness of 1 to 2000 micrometers.

6. The cover assembly of claim 1, wherein the polymer film comprises a polyacetal, poly(C₁₋₆ alkyl)acrylate, polyarylate, polycarbonate, polyester, polyetherimide, polyimide, poly(C₁₋₆ alkyl)methacrylate, polyolefin, polystyrene, polyurethane, polyvinyl alcohol, polyvinyl ester, polyvinyl ether, polyvinyl halide, polyvinyl nitrile, polyvinyl ketone, polyvinylidene fluoride, or a combination comprising at least one of the foregoing thermoplastic polymers.

7. The cover assembly of claim 1, wherein the polymer film has a thickness of
1 micrometer to 20 millimeters; or
less than 300 micrometers.

8. The cover assembly of claim 1, wherein the cover assembly further comprises a second optically clear adhesive layer.

9. The cover assembly of claim 1, wherein the cover assembly further comprises a functional layer disposed on at least a portion of the glass layer, the polymer film, or both.

10. The cover assembly of claim 9, wherein the functional layer comprises an anti-reflection coating, an anti-glare coating, an antimicrobial coating, a conductive layer, an anti-fingerprint coating, an anti-smudge coating, an anti-fog coating, or a combination comprising at least one of the foregoing.

11. The cover assembly of claim 9 or 10, wherein the functional layer comprises a conductive layer disposed on at least a portion of the polymer film on a side opposite the first optically clear adhesive layer.

12. The cover assembly of claim 1, further comprising a decorative pattern disposed on at least a portion of the glass layer, the polymer film, or both, or wherein the glass layer, the polymer film, or both is textured.

13. The cover assembly of claim 1, wherein the cover assembly exhibits curvature in a direction perpendicular to the first and second surfaces of the glass layer, or wherein the cover assembly is at least partially curvilinear.

14. A method of manufacturing the cover assembly of claim 1, the method comprising,
applying the optically clear adhesive to at least a portion of the first surface of the glass layer; and
applying the polymer film to the optically clear adhesive on a side opposite the first surface of the glass layer.

15. An electronic device comprising the cover assembly of claim 1.

16. The electronic device of claim 15, comprising the cover assembly disposed on a display of the electronic device.

17. The electronic device of claim 16, wherein the display is heads-up display, a display console, or a touch screen display.

18. The electronic device of claim 15, wherein the device is a lighting device.

19. The electronic device of claim 15, wherein the cover assembly is laminated onto the device, or molded onto the device, or welded onto the device.

20. The electronic device of claim 15, wherein the cover assembly exhibits curvature in a direction perpendicular to the first and second surfaces of the glass layer, and the display of the electronic device exhibits a curvature that is complementary to the curvature of the cover assembly.
